(19) United States
(12) Patent Application Publication
(10) Pub. No.: US 2025/0306337 A1
(43) Pub. Date: Oct. 2, 2025

(54) MIRROR MEMBER

(71) Applicant: TOPCON CORPORATION, Tokyo (JP)

(72) Inventor: Eiji KUROKI, Tokyo (JP)

(73) Assignee: TOPCON CORPORATION, Tokyo (JP)

(21) Appl. No.: 19/092,166

(22) Filed: Mar. 27, 2025

(30) Foreign Application Priority Data
Mar. 29, 2024 (JP) 2024-055284

(51) Int. Cl. G02B 7/182; G01S 7/481; G02B 26/08; G02B 26/10

(52) U.S. Cl. CPC G02B 7/1821; G01S 7/4817; G02B 26/0816; G02B 26/10

(57) ABSTRACT

A support part in a mirror member includes a first support rib connected to the mirror and extending in a radial direction from a rotation center of the mirror to the inner edge; a second support rib connected to the first support rib and extending in a first circumferential direction about the rotation center; a third support rib connected to the second support rib and extending in a second circumferential direction, opposite to the first circumferential direction, on the outer diameter side of the rotation center with respect to the second support rib; a fourth support rib connected to the third support rib and extending in the first circumferential direction outward of the rotation center with respect to the third support rib; and a fifth support rib extending in the radial direction from the fourth support rib and connecting to both the fourth support rib and the inner edge.

### CROSS-REFERENCE TO RELATED APPLICATIONS

This application claims the benefit of priority under 35 U.S.C. 119 from Japanese Patent Application No. 2024-055284, filed Mar. 29, 2024; the disclosure of which is incorporated herein by reference in its entirety.

### BACKGROUND

The present disclosure relates to a mirror member.

Traditionally, scanner devices capable of optical scanning have been proposed, which includes a mirror that reflects light and is oscillatably supported. For example, Japanese Unexamined Patent Publication No. 2024-19458 discloses a scanner device (mirror scanner) including a mirror having a first surface that is configured to reflect light and that is oscillatable about an oscillation axis, a permanent magnet arranged on a second surface opposite to the first surface of the mirror, and a yoke provided on the second surface side of the mirror. Such a scanner device includes a support plate, a pair of torsion bars extending along the oscillation axis from the support plate, and a mirror oscillatably supported by the support plate and the torsion bars. Further, a mirror member (mirror body) of Japanese Unexamined Patent Publication No. 2024-19458 including the support plate, the torsion bars, and a mirror is described to be integrally formed by processing a semiconductor wafer.

### SUMMARY

The scanner device of Japanese Unexamined Patent Publication No. 2024-19458 is formed by processing a semiconductor wafer, which requires careful handling and may increase manufacturing costs. Further, providing three or more support parts (e.g., torsion bars of Japanese Unexamined Patent Publication No. 2024-19458) to enable dual-axis operation of the mirror in the scanner device makes it difficult to ensure drive accuracy, durability, and the like, so ensuring their reliability is desired.

An object of the present disclosure is to provide a highly reliable mirror member that is easily manufactured.

A mirror member of the present disclosure includes: a main frame; a mirror; and a plurality of support parts that radially connect an inner edge of the main frame and the mirror, wherein each of the support parts includes: a first support rib connected to the mirror and extending in a radial direction from a rotation center of the mirror to the inner edge; a second support rib connected to the first support rib and extending in a first circumferential direction about the rotation center; a third support rib connected to the second support rib and extending in a second circumferential direction, opposite to the first circumferential direction, on the outer diameter side of the rotation center with respect to the second support rib; a fourth support rib connected to the third support rib and extending in the first circumferential direction outward of the rotation center with respect to the third support rib; and a fifth support rib extending in the radial direction from the fourth support rib and connecting to both the fourth support rib and the inner edge.

A mirror member of the present disclosure using the above-described approach has high reliability and is easily manufactured.

### BRIEF DESCRIPTION OF THE DRAWINGS

FIG. 1 is a configuration diagram of a light source device of an embodiment of the present disclosure.

FIG. 2 is a perspective view of a part of the scanner device.

FIG. 3 is an exploded perspective view of a mirror member.

FIG. 4 is a front view of a mirror support member.

FIG. 5 is an enlarged view of the mirror support member taken along lines A-A′ and B-B′ in FIG. 4.

FIG. 6 is a front view of the mirror member.

FIG. 7 is a rear view of the mirror member.

FIG. 8 is a plan view and a bottom view of the mirror member.

FIG. 9 is a left side view of the mirror member.

### DETAILED DESCRIPTION

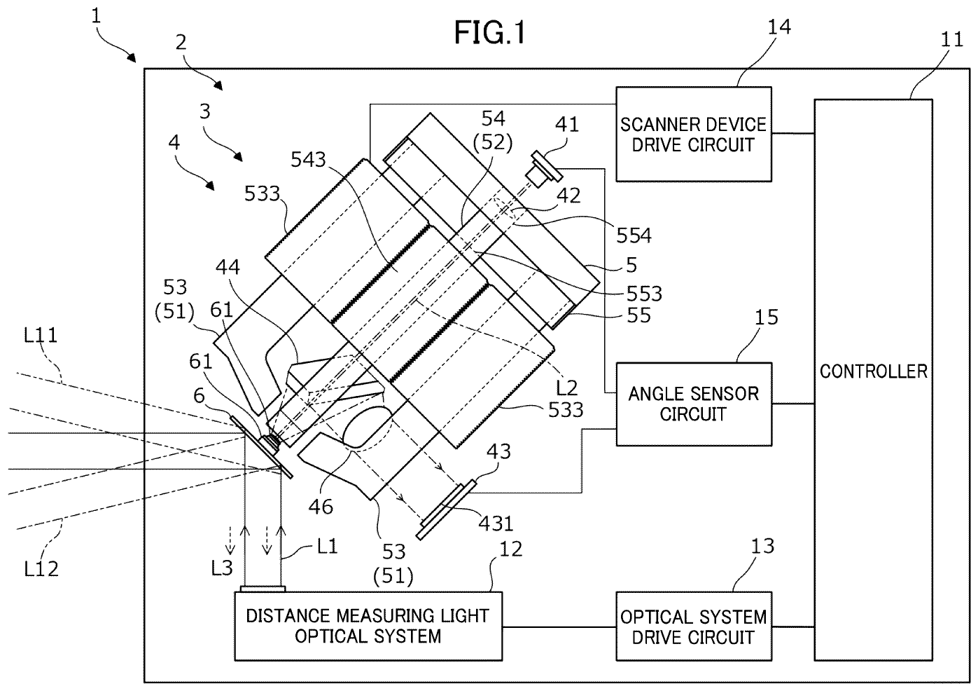

Embodiments of the present disclosure will be described in detail with reference to the drawings. FIG. 1 is a configuration diagram of a light source device 1. The light source device 1 is configured to emit laser light into space. The light source device 1 is used, for example, as a light source of a laser distance measuring device or a light detection and ranging (LiDAR) sensor. The light source device 1 includes a controller 11, a distance measuring light optical system 12, an optical system drive circuit 13, and a scanner device 2.

The controller 11 controls operations of the optical system drive circuit 13, a scanner device drive circuit 14, an angle sensor circuit 15, and the like. The controller 11 executes the functions and/or methods implemented by codes or commands included in the programs stored in the storage (not shown). The controller 11 may include a central processing unit (CPU), a micro-processing unit (MPU), GPU, a microcontroller unit (MCU), a processor core, a multiprocessor, ASIC, FPGA, and the like. The controller 11 may include a logic circuit or a dedicated circuit formed in an integrated circuit, for example, to execute the processing disclosed in the embodiments. These circuits may be one or more integrated circuits. A single integrated circuit may execute the plural types of processing described in the embodiments.

The storage (not shown) of the light source device 1 has the function of storing various programs or various data that are needed. The storage can store acquired information, such as signals measured. The storage is implemented as various storage media, such as a hard disk drive (HDD), a solid state drive (SSD), and a flash memory.

The distance measuring light optical system 12 includes a light emitting element configured to emit laser light, an optical element including a lens, a mirror, or the like, which is configured to guide laser light emitted by the laser emitting element, and a light receiving element configured to detect laser light. The optical element may include a diffusion plate, a light tunnel, a microlens array, a condenser lens, a filter, or the like to adjust the beam width or brightness distribution. The light receiving element can receive light emitted from the laser emitting element, which has been reflected by an object outside the light source device 1. The distance measuring light optical system 12 emits, to the mirror 6 (deflection member) of the scanner device 2, laser light L1 that is distance measuring light (also referred to as “scanning light”)

The optical system drive circuit 13 controls light emission of the light emitting element of the distance measuring light optical system 12. Further, the optical system drive circuit 13 detects light received by the light receiving element of the distance measuring light optical system 12, converts the light into information, and transfers the information to the controller 11.

The scanner device 2 reflects the laser light L1 emitted from the distance measuring light optical system 12 in a direction and at an angle selected from a predetermined range of solid angles and emits the laser light L1 as output light to the outside of the light source device 1. The scanner device 2 controls the angle of the mirror 6 to reflect the laser light L1 in different directions, as exemplified by laser light L11 or laser light L12. Further, the scanner device 2 guides light having entered from outside the light source device 1 to the distance measuring light optical system 12. Light entering from outside the light source device 1 is reflected light L3 reflected by an object outside the light source device 1. Note that, depending on the configuration of the light source device 1, the laser light L1 emitted from the light source device 1 may be guided to another optical system inside the light source device 1.

The scanner device 2 includes a deflection control device 3 and an inclination detection device 4. The deflection control device 3 of the present embodiment includes a yoke member 5, a mirror 6, and a scanner device drive circuit 14. The inclination detection device 4 of the present embodiment includes a light source 41 configured to emit laser light L2, a first lens 42, a detection circuit substrate 43, a beam splitter 44, a second lens 46, and an angle sensor circuit 15. The inclination detection device 4 uses the laser light L2 as detection light for detecting the inclination of the mirror 6. The mirror 6 also functions as a part of the inclination detection device 4.

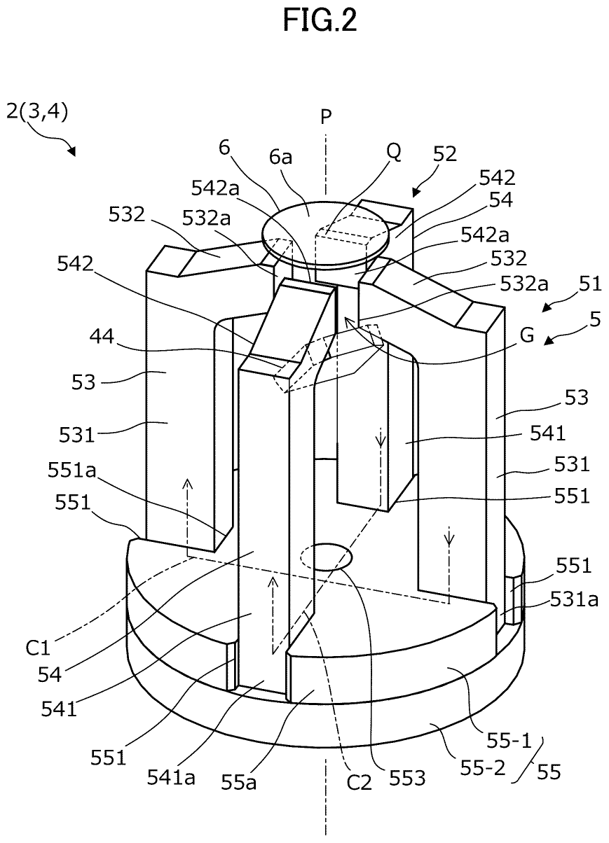

FIG. 2 is a perspective view of a part of the deflection control device 3 and a part of the inclination detection device 4 of the scanner device 2. Note that the mirror 6 side is regarded as the upper side of the scanner device 2, whereas the base member 55 side of the yoke member 5 is regarded as the lower side, in the description of the scanner device 2.

The yoke member 5 includes a first yoke 51 and a second yoke 52, which is different from the first yoke 51 and which is arranged in a rotationally symmetrical position about an axis P of the scanner device 2. The first yoke 51 includes a pair of first arm members 53, 53 having first end portions 532a, 532a, and the base member 55 connected to portions opposite to the first end portions 532a, 532a of the first arm members 53, 53. Further, the second yoke 52 includes a pair of second arm members 54, 54 having second end portions 542a, 542a, and the base member 55 connected to portions opposite to the second end portions 542a, 542a of the second arm members 54, 54.

The first yoke 51 and the second yoke 52 have magnetic properties. The first arm member 53 and the second arm member 54 have substantially quadrangular prism-shaped body parts 531, 541 having a rectangular cross-section, and protrusions 532, 542 extending on one side of the body parts 531, 541 and bent into a substantially L shape, respectively. The protrusions 532, 542 have, at their respective leading ends, a flat first end portion 532a and a flat second end portion 542a.

The body part 531 of each of the first arm members 53 has a yoke coil 533 wound about its outer circumference (see FIG. 1). The yoke coils 533 of the pair of first arm members 53 are serially connected to each other. Further, the body part 541 of each of the second arm members 54 has a yoke coil 543 wound about its outer circumference (FIG. 1 only shows one of the second arm members 54 or the yoke coil 543). The yoke coils 543 of the pair of second arm members 54 are also serially connected to each other. Thus, the yoke member 5 and the yoke coils 533, 543 form an electromagnet. The scanner device drive circuit 14 drives the electromagnet to control the angle of the mirror 6 based on an instruction from the controller 11.

The base member 55 has a magnetic property. The base member 55 has a first base member 55-1 and a second base member 55-2, both having a disc shape. The first base member 55-1 has cut-out portions 551 on two sets of opposing side edges 55a. The outer diameters of the first base member 55-1 and the second base member 55-2 are substantially the same (see FIG. 2). The first base member 55-1 has the cut-out portions 551 with a substantially rectangular shape in plan view (details not illustrated) and a circular opening 553 penetrating in the thickness direction. As shown in the assembled yoke member 5 of FIG. 2, the opening 553 is arranged on an axis P passing through the gap G (magnetic gap) between the pair of first end portions 532a and between the pair of second end portions 542a.

The second base member 55-2 has substantially the same thickness as the first base member 55-1. The second base member 55-2 also has a circular opening 554 penetrating in the thickness direction (see FIG. 1). The opening 554 is also arranged on the axis P passing through the gap G in the assembled yoke member 5 shown in FIG. 2. Thus, the opening 554 and the opening 553 are coaxially arranged. Further, the inner diameter of the opening 554 is substantially the same as that of the opening 553.

The first arm member 53 and the second arm member 54 are accommodated in the cut-out portions 551 and connected to the first base member 55-1. The first arm member 53 is accommodated so that it is in surface contact with the inner surface 551a of the cut-out portion 551 facing the center of the first base member 55-1 and its end portion 531 a is in substantial surface contact with the upper surface of the second base member 55-2. Similarly, the second arm member 54 is accommodated so that it is in surface contact with the inner surface 551a of the cut-out portion 551 facing the center of the first base member 55-1 and its end portion 541a is in substantial surface contact with the upper surface of the second base member 55-2. Therefore, the second base member 55-2 is arranged on top of the first base member 55-1 so as to cover from below the end portions 531a and 541a of the first arm member 53 and the second arm member 54, each accommodated in the cut-out portion 551.

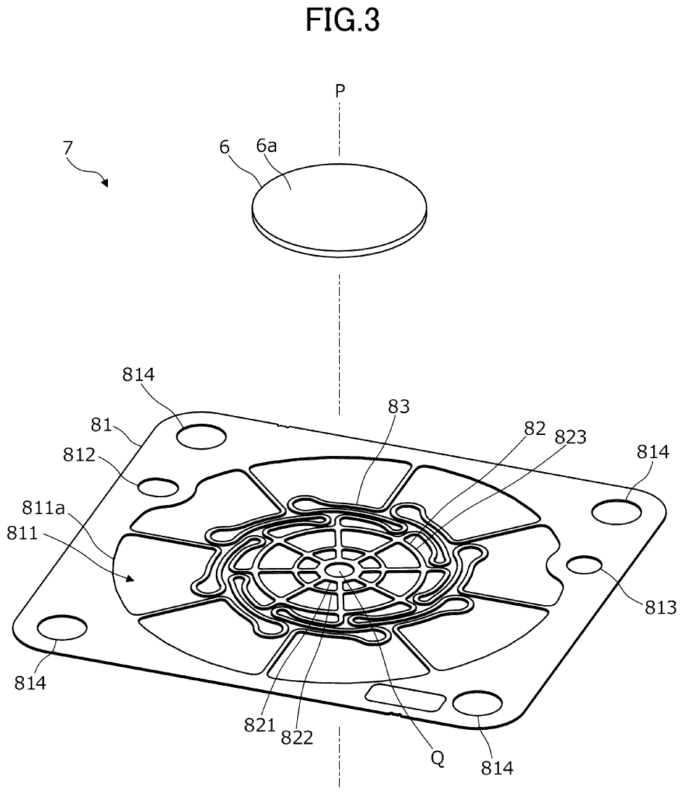

FIG. 3 is a perspective view of the mirror 6. The mirror 6 is an optical member arranged between the pair of first end portions 532a and between the pair of second end portions 542a in a plan view of the scanner device 2 (see FIGS. 1 and 2). The mirror 6 includes a permanent magnet 61 and a reflecting member 62 fixed to the yoke member 5 side. As shown in the exploded perspective view of FIG. 3, the mirror 6 has a circular flat plate shape and has a reflector 6a that is a functional surface configured to reflect the laser light L1 (see FIG. 2). The reflector 6a has a metal reflective film formed through vapor deposition.

The permanent magnet 61 is a magnet fixed to the mirror 6 and has an annular shape having an opening penetrating along the axis P direction shown in FIG. 2 (disc-shape with an opening). The controller 11 controls the inclination direction and inclination angle of the mirror 6 by supplying current to the yoke coils 533 and 543, thereby applying an external force to the mirror 6 via the yoke member 5 and the permanent magnet 61.

The permanent magnet 61 has a substantially disc-shaped form that is rotationally symmetric about the axis P in the state of FIG. 1 where the mirror 6 is not inclined to the axis P. The permanent magnet 61 has one of the S or N poles at one end in the thickness direction (axis P direction) and the other of the S or N poles at the other end.

The reflecting member 62 has a reflection surface that reflects laser light L2 emitted from the light source 41 in a direction and angle corresponding to the reflection angle of the mirror 6. One or more reflection surfaces may be provided and may be flat or spherical (e.g., a concave curved surface) (details not shown). Thus, the detection unit 431 of the detection circuit substrate 43 detects the light receiving position of the reflected light of the laser light L2 from the reflecting member 62, allowing the controller 11 (angle sensor circuit 15) to detect the inclination direction and inclination angle of the mirror 6 corresponding to the light receiving position.

Note that the reflection surface of the reflecting member 62 may be formed by cutting or, for example, by resin molding. When using resin molding to form the reflection surface, the reflection surface may be formed by mirror-finishing the surface of the flat reflecting member and fixing the back surface of the reflection surface formed on the reflecting member 62 to the side opposite to the functional part (reflector 6a) of the mirror 6 with an adhesive or the like.

The light source 41 is a laser emitting element configured to emit laser light L2 as detection light. The first lens 42 is a condenser lens that focuses the laser light L2 emitted from the light source 41. The laser light L2 focused by the first lens 42 is emitted onto the beam splitter 44.

The detection unit 431 on the detection circuit substrate 43, serving as a light receiving unit, is a two-dimensional sensor. The detection unit 431 can use, for example, a profile sensor such as a CCD or a CMOS sensor, both of which are collections of pixels, or an optical position-sensitive detector (PSD) or a four-quadrant photodetector.

The beam splitter 44 in this embodiment is a half mirror. The beam splitter 44 allows part of laser light L2 emitted from the first lens 42 to pass through and reach the reflection surface of the reflecting member 62 along the axis P. Further, the beam splitter 44 reflects part of laser light L2 reflected by the reflecting member 62 and guides that part to the detection unit 431. Between the beam splitter 44 and the detection unit 431, the second lens 46 is arranged. The second lens 46 is a condenser lens that focuses the laser light L2 reflected by the beam splitter 44.

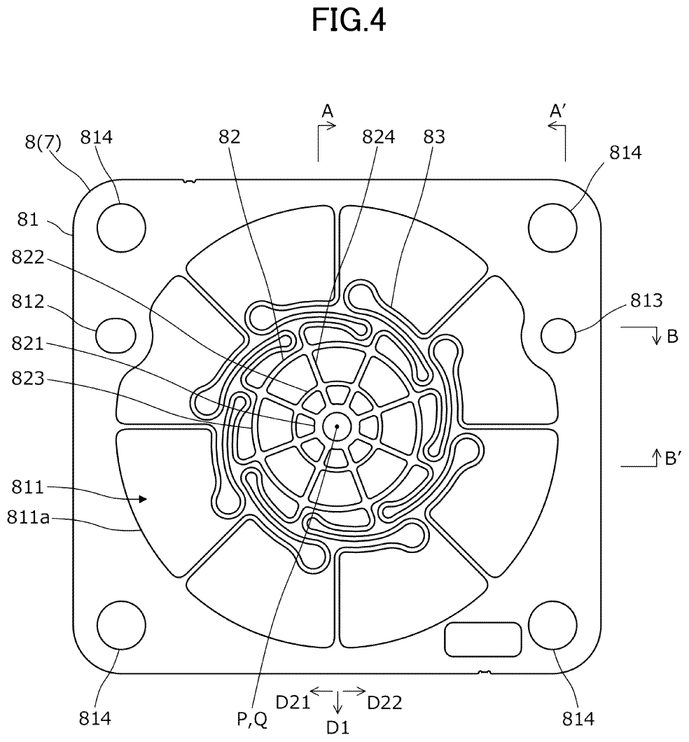

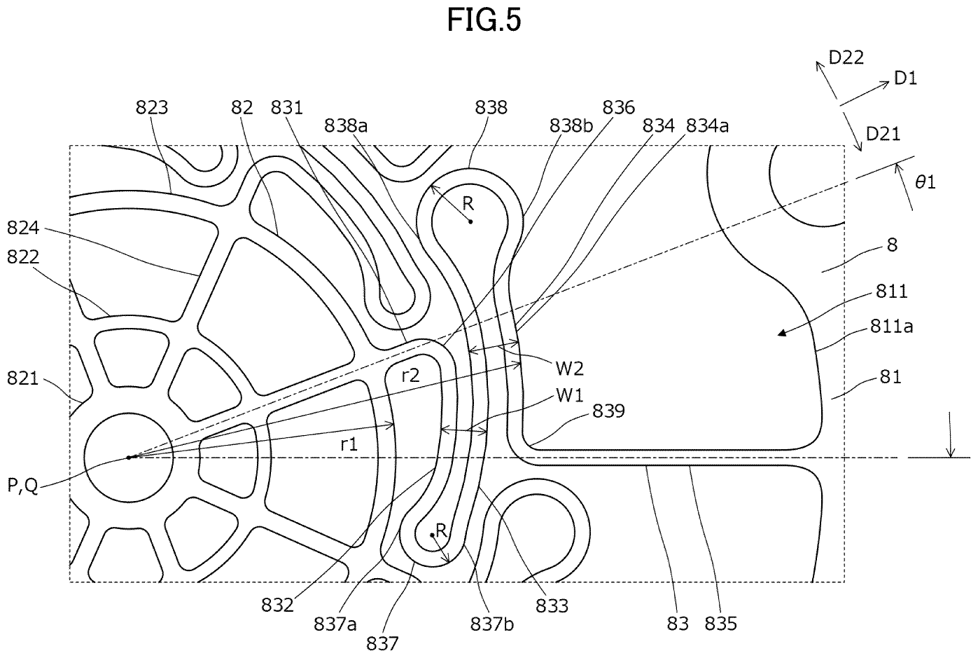

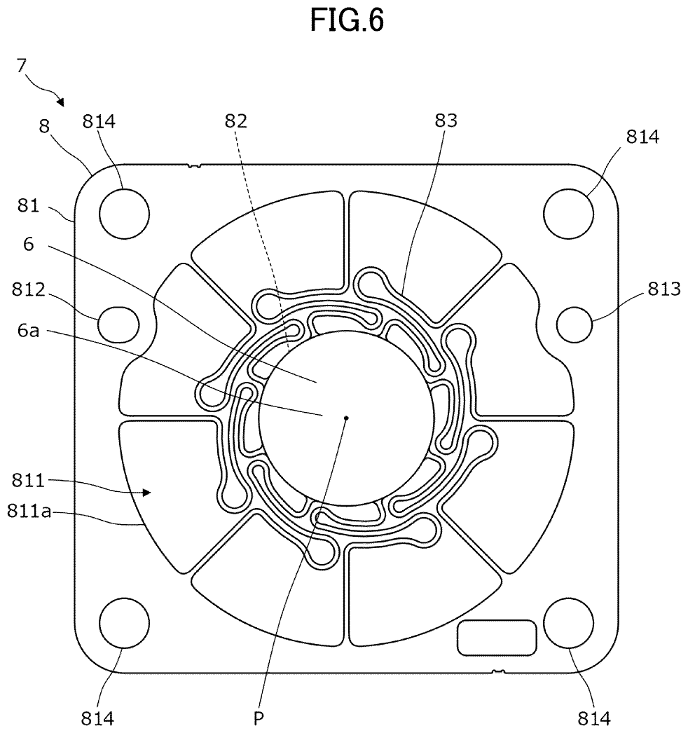

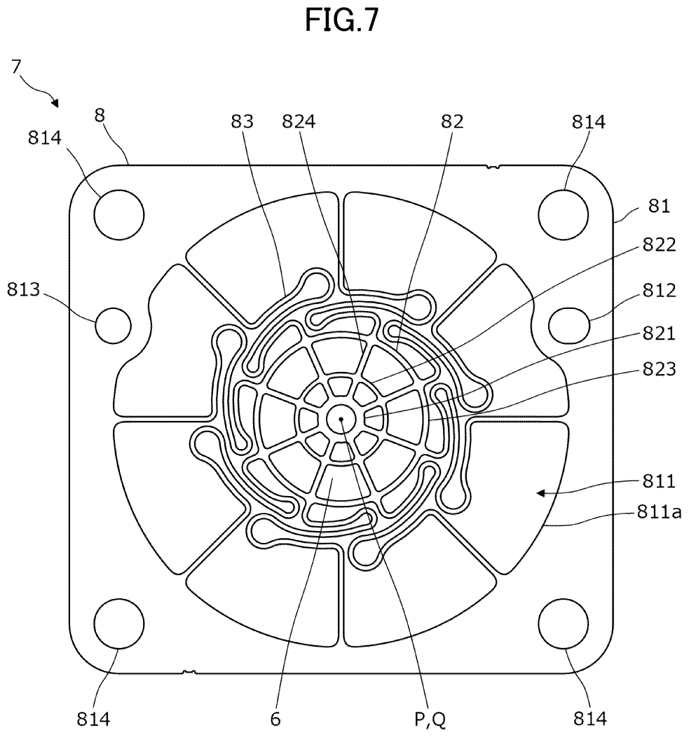

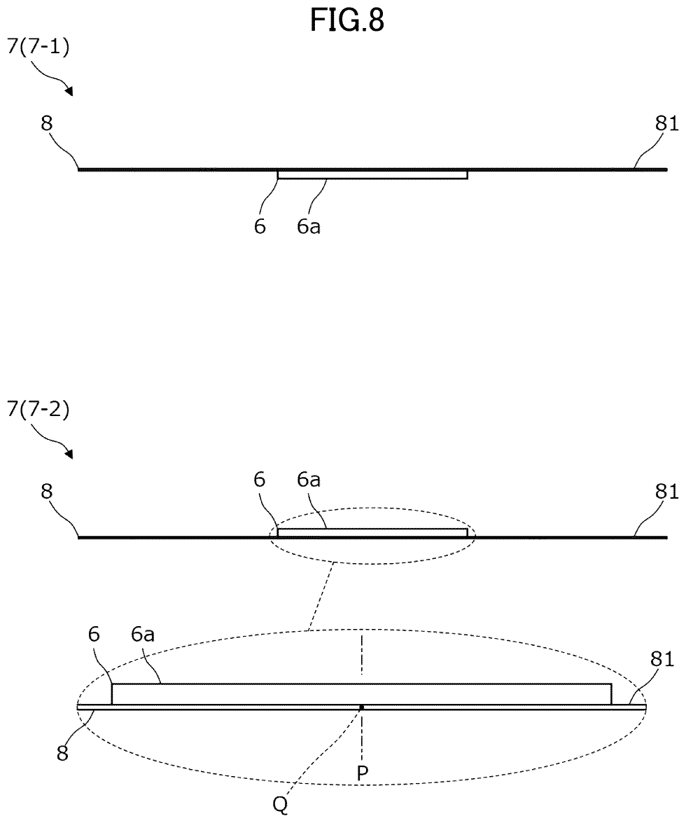

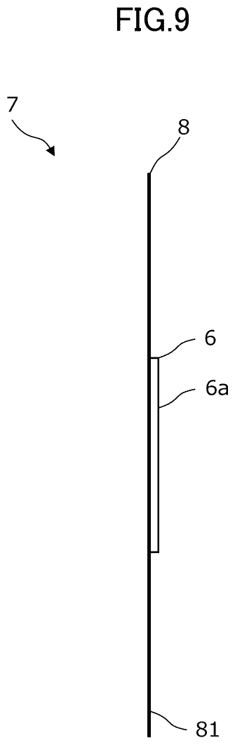

Next, the mirror member 7 will be described. FIG. 3 is an exploded perspective view of the mirror member 7. The mirror member 7 includes a mirror support member 8 and the mirror 6. FIG. 4 is a front view of the mirror support member 8. FIG. 5 is an enlarged view of the mirror support member 8 taken along lines A-A′ and B-B′ in FIG. 4. FIG. 6 is a front view of the mirror member 7. FIG. 7 is a rear view of the mirror member 7. FIG. 8 is a plan view (7-1) and a bottom view (7-2) of the mirror member 7. Further, FIG. 9 is a left side view of the mirror member 7. Note that the right side view of the mirror member 7 is omitted because it is symmetrical to the left side view.

The mirror support member 8 of the present embodiment is made of metal (e.g., stainless steel). Forming the mirror support member 8 with metal provides processability, high proof strength, high spring limit stress, and material availability. The mirror support member 8 includes a main frame 81, a mirror support part 82 disposed substantially at the center of the main frame 81, and a plurality of support parts 83 configured to support the mirror 6. The support parts 83 radially connects an inner edge 811a of the main frame 81 and the mirror 6 fixed to the mirror support part 82.

The main frame 81 is formed in the form of a substantially square plate. The main frame 81 has a substantially circular opening 811 inside. Positioning holes 812 and 813 are provided at both end edges of the main frame 81 for positioning relative to the yoke member 5. One of the positioning holes 812 is an elongated hole, and the other positioning hole 813 is a circular hole. Further, a fixing hole 814 for fixing relative to the yoke member 5 is provided in each of the four corner portions of the main frame 81.

The mirror support part 82 is a flat region having a circular flat plate shape. The mirror support part 82 includes a first annular portion 821, a second annular portion 822, and a third annular portion 823 which are coaxial with the axis P. The first annular portion 821 is arranged inside the second annular portion 822. The third annular portion 823 is arranged outside the second annular portion 822. Further, the annular portions 821 to 823 are connected via a plurality of radial support ribs 824 (eight in this embodiment) extending in radial directions D1 from the rotation center Q (also see the enlarged view of FIG. 8) on the axis P to the inner edge 811a of the opening 811. The radial support ribs 824 are arranged radially around the rotation center Q at equal intervals.

As illustrated in FIG. 5, the support part 83 includes a first support rib 831, a second support rib 832, a third support rib 833, a fourth support rib 834, and a fifth support rib 835, which are sequentially formed from the mirror support part 82 toward the inner edge 811a side of the main frame 81. Each of the support ribs 831 to 835 is formed to be flat and to have substantially the same width. The mirror 6 is mainly supported by a plurality of support parts 83 and is rotatable about two axes (or tiltable about two axes).

The first support rib 831 is connected to the mirror 6 and extends in a radial direction D1 from the rotation center Q to the inner edge 811a, as viewed from the front of the mirror 6. The first support rib 831 is arranged on the extension of the radial support rib 824, which is wider than the first support rib 831.

The second support rib 832 is connected to the first support rib 831 and extends in a first circumferential direction D21 (clockwise when viewed from the front in FIG. 5) about the rotation center Q. The third support rib 833 is connected to the second support rib 832 and extends in a second circumferential direction D22 (counterclockwise when viewed from the front in FIG. 5), opposite to the first circumferential direction D21, on the outer diameter side of the rotation center Q with respect to the second support rib 832. The fourth support rib 834 is connected to the third support rib 833 and extends in the first circumferential direction D21, outward of the rotation center Q with respect to the third support rib 833. The fifth support rib 835 extends in a radial direction DI from the fourth support rib 834 and connects to both the fourth support rib 834 and the inner edge 811a of the opening 811.

The first support rib 831 is positioned in the second circumferential direction D22 relative to the fifth support rib 835. The second support rib 832 and the third support rib 833 are arranged substantially parallel to each other. The first support rib 831 and the second support rib 832 are connected via a first bent portion 836 formed in a substantially right-angled arc shape. The angular difference θ1 between the first support rib 831 and the fifth support rib 835 about the rotation center Q is smaller than that between the adjacent first support ribs 831 of the support part 83 about the rotation center Q (or the angular difference between the adjacent fifth support ribs 835 of the support part 83 about the rotation center Q).

The second support rib 832 and the third support rib 833 are connected via a first bent-back portion 837 having a substantially arc shape, which is wider than the outer edge width W1 of the second support rib 832 and the third support rib 833. The second support rib 832 and the third support rib 833 are connected via a first bent-back portion 837 having a substantially arc shape, which is wider than the outer edge width W1 of the second support rib 832 and the third support rib 833. The second support rib 832 extends from the first support rib 831 side toward the third support rib 833 side (i.e., in the first circumferential direction D21) while gradually tapering toward the rotation center Q side.

The third support rib 833 is formed longer than the second support rib 832. The third support rib 833 and the fourth support rib 834 are arranged substantially parallel to each other. The third support rib 833 and the fourth support rib 834 are connected via a second bent-back portion 838 having a substantially arc shape, which is wider than a distance W2 between the outer edges of the third support rib 833 and the fourth support rib 834. The second bent-back portion 838 is formed in a substantially arc shape with a larger diameter than the first bent-back portion 837. The second bent-back portion 838 has a bulging portion 838b on the fourth support rib 834 side, which protrudes more than a bulging portion 838a on the third support rib 833 side, and as a whole, the second bent-back portion 838 extends toward the inner edge 811a side relative to the rotation center Q. The second bent-back portion 838 overlaps with the first bent-back portion 837 of the adjacent support part 83 in the radial direction D1.

The fourth support rib 834 and the fifth support rib 835 are connected via a second bent portion 839 formed in a substantially right-angled arc shape. In this embodiment, the circumferential spring radius r2 from the rotation center Q to the outer edge of the fourth support rib 834 is set to be twice or less than the radius of the mirror support part 82 (i.e., the mirror radius r1 from the rotation center Q to the outer edge of the mirror support part 82). Further, the circumferential spring radius r2 is set to be longer than the fifth support rib 835. Therefore, the fifth support rib 835 is formed longer than the distance from the mirror 6 to the outer edge 834a of the fourth support rib 834.

The scanner device drive circuit 14 shown in FIG. 1 includes yoke coils 533, 543 as load circuits, a not-shown drive circuit (or switching circuit), and the like. The controller 11 controls the scanner device drive circuit 14 to supply excitation current to the yoke coil 533 and the yoke coil 543. This generates a magnetic field in the first magnetic path C1 of the first yoke 51 and the second magnetic path C2 of the second yoke 52, so that the magnetic field is directed between the first end portions 532a of the first yoke 51 and the magnetic field is directed between the second end portions 542a of the second yoke 52 at a strength designated by the controller 11. The permanent magnet 61 receives attraction or repulsion from the magnetic field directed between the first end portions 532a of the first yoke 51 and the magnetic field directed between the second end portions 542a of the second yoke 52. The mirror 6 is controlled about the rotation center Q at an inclination direction and inclination angle corresponding to a control instruction, so as to achieve a predetermined inclination direction and inclination angle, according to the strength and strength ratio of these magnetic fields.

Note that, in a no-load state where a magnetic field by the electromagnet does not act, the mirror 6 is urged by the restoring force (elastic force) of the support part 83 to a reference position where the axis P of the yoke member 5 and the reflector 6a are substantially vertical (the state of the mirror 6 shown in FIG. 1).

The controller 11 determines the inclination (inclination direction and inclination angle) of the mirror 6 based on the light receiving position of the laser light L2 received by the detection unit 431. The controller 11 can determine the inclination of the mirror 6 by calculating the position of the optical axis of the laser light L2 incident on the detection unit 431. Note that the controller 11 may determine the correspondence between the position of the optical axis with respect to the reference point on the light receiving surface of the detection unit 431 and the inclination of the mirror 6 by calculation or may determine the same by referring to a pre-stored correspondence table.

Thus, the mirror member 7 of the present embodiment, which includes a main frame 81, the mirror 6, and a plurality of support parts 83 that connect an inner edge 811a of the main frame 81 to the mirror 6 in radial directions, has been described above. In this mirror member 7, each of the support parts 83 includes a first support rib 831 connected to the mirror 6 and extends in a radial direction D1 from the rotation center Q of the mirror 6 to the inner edge 811a; a second support rib 832 connected to the first support rib 831 and extends in a first circumferential direction D21 about the rotation center Q; a third support rib 833 connected to the second support rib 832 and extends in a second circumferential direction D22, opposite to the first circumferential direction D21, on the outer diameter side of the second support rib 832, about the rotation center Q; a fourth support rib 834 connected to the third support rib 833 and extends in the first circumferential direction D21 on the outer side of the third support rib 833 about the rotation center Q; a fifth support rib 835 extending in a radial direction D1 from the fourth support rib 834 and connecting to both the fourth support rib 834 and the inner edge 811a.

This allows the support part 83 to be extended longer within the limited space inside the main frame 81, and allows the mirror support part 82, which supports the mirror 6, to have a wider operating range in the axis P. By forming the support part 83 in a reciprocating spring shape and offsetting the connection positions on the mirror 6 side and the main frame 81 side in the angular direction with respect to the rotation center Q, it is possible to improve the linearity of light scanning (linear drive) in a primary direction of the mirror 6 and enhance the motion performance in the secondary direction, such as circular motion. The above configuration enables the formation of a mirror member 7, which is highly reliable and is easily manufactured.

Further, forming the third support rib 833 longer than the second support rib 832 increases the total length of the support part 83, thereby expanding the drive range (e.g., range of inclination angle) of the mirror 6.

Further, using a metal material for the mirror support member 8 reduces material, processing, and development costs compared to an MEMS mirror manufactured using a silicon process, such as a traditionally marketed small oscillating mirror. Further, since such a mirror support member 8 is not as fragile as silicon MEMS, the mirror support member 8 is easier to handle. This contributes to a reduction in manufacturing costs.

Further, the control of the inclination direction and inclination angle of the mirror 6 becomes easier as the trajectory of the laser light L1 reflected by the mirror 6 (in other words, the drive trajectory of the mirror 6) more closely follows the input signals; for example, being more linear with respect to the input signals.

For example, to improve the drive trajectory, it is preferable to take the following into account while focusing on the mode ratio of the resonance frequency. When the frequency ratio of a primary mode and a secondary mode approaches an integer, their resonance frequencies are more likely to overlap. Therefore, to prevent or reduce disturbances in the drive trajectory, the radius ratio a of the circumferential spring radius r2 to the mirror radius r1 and the resonance frequency ratio f of the secondary resonance frequency to the primary resonance frequency exhibit a substantially linear correlation based on the simulation results. Reducing the radius ratio a shifts the resonance frequency ratio f further from an integer multiple. Specifically, to reduce the radius ratio a while keeping the mirror radius r1 fixed, the circumferential spring radius r2 needs to be reduced.

In one exemplary configuration of the mirror member 7 of the present embodiment, the fifth support rib 835 is formed longer than a distance from the mirror 6 to the outer edge of the fourth support rib 834, allowing reduction of the radius ratio a of the circumferential spring radius r2 to the mirror radius r1. This suppresses or reduces trajectory disturbances of the mirror 6 due to vibration.

Further, a configuration in which the first bent-back portion 837 bulges toward the rotation center Q side relative to the inner edge 811a, and the second bent-back portion 838 bulges toward the inner edge 811a relative to the rotation center Q has been described. This increases the curvature radius R of each of the bent-back portions 837 and 838, while further reducing the circumferential spring radius r2 of the fourth support rib 834 and bringing the radius r2 closer to the mirror radius r1.

The first bent-back portion 837 and the second bent-back portion 838 are areas where stress tends to concentrate due to the swinging displacement of the mirror. Therefore, to alleviate stress concentration, the curvature radius R is preferably increased as much as possible.

In one exemplary configuration of the mirror member 7 of the present embodiment described above, the second support rib 832 and the third support rib 833 are connected via a first bent-back portion 837 having an arc shape, which is wider than a distance W1 between the outer edges of the second support rib 832 and the third support rib 833, and the third support rib 833 and the fourth support rib 834 are connected via a second bent-back portion 838 having an arc shape, which is wider than a distance W2 between the outer edges of the third support rib 833 and the fourth support rib 834. This bump-like bulge in the bent-back portion allows for both a small radius ratio a and a large bent-back curvature radius R, and reduces the maximum Mises stress (e.g., −30%). This shape allows the mirror support member 8 to reduce stress concentration and achieve both a wider scanning angle and higher breaking resistance.

Further, the second support rib 832 extends from the first support rib 831 side toward the third support rib 833 side while tapering toward the rotation center Q side. This allows the arrangement of the second bent-back portion 838 on the outer side of the first bent-back portion 837 in the radial direction D1, thereby allowing for a larger curvature radius R and a longer overall support part 83.

Further, in one exemplary configuration of the mirror member 7 of the present embodiment, the first support rib 831 is positioned in the second circumferential direction D22 relative to the fifth support rib 835. As described above, by providing an angular difference between the first support rib 831 extending from the mirror support part 82, which serves as a frame for attaching the mirror 6, and the fifth support rib 835 connected to the main frame 81, the linearity of light scanning (linear driving) by the mirror 6 in the primary direction can be improved. The angle can be optimized through simulation. For example, θ1 is 21° in the present embodiment.

The embodiments of the present disclosure have been described above, but the aspects of the present disclosure are not limited to the embodiment.

For example, the circumferential direction (first circumferential direction D21, second circumferential direction D22) encompasses directions that are substantially parallel to the circumferential direction about the rotation center Q and is not limited to a strictly circumferential direction. Further, the radial direction D1 includes directions that are substantially parallel to the outward radial direction from the rotation center Q toward the inner edge 811a side of the main frame 81 and is not limited to a strictly radial direction.

Further, it is preferable to provide an axial offset by setting different angles for the first support rib 831 and the fifth support rib 835 so that they become non-coaxial. However, the configuration is not limited to this; they may be arranged in parallel while being non-coaxial to provide an axial offset. Arranging the first support rib 831 and the fifth support rib 835 in parallel also allows for favorable linearity in the direction of the reflected light when the mirror 6 is inclined in one direction.

The support part 83 may be formed with the first bent-back portion 837 and the second bent-back portion 838 being wider than any of the first support rib 831 to fifth support rib 835.

The distance measuring light optical system 12 of the present disclosure may also be used to guide light for purposes other than distance measurement.

Further, the mirror support member 8 is not limited to supporting a deflection member and may support other optical members that rotate about the rotation center Q. The mirror 6 may be another optical member or a non-optical member instead of the deflection member.

An exemplary configuration of the present disclosure is as follows.

[1] A mirror member, including
a main frame, a mirror, and a plurality of support parts that radially connect an inner edge of the main frame and the mirror, wherein
each of the support parts includes:
   a first support rib connected to the mirror and extending in a radial direction from a rotation center of the mirror to the inner edge;
   a second support rib connected to the first support rib and extending in a first circumferential direction about the rotation center;
   a third support rib connected to the second support rib and extending in a second circumferential direction, opposite to the first circumferential direction, on the outer diameter side of the rotation center with respect to the second support rib;
   a fourth support rib connected to the third support rib and extending in the first circumferential direction outward of the rotation center with respect to the third support rib; and
   a fifth support rib extending in the radial direction from the fourth support rib and connecting to both the fourth support rib and the inner edge.

[2] The mirror member of [1], wherein the first support rib is positioned in the second circumferential direction relative to the fifth support rib.

[3] The mirror member of [1], wherein
the second support rib and the third support rib are connected via a first bent-back portion in an arc shape, which is wider than a distance between outer edges of the second support rib and the third support rib, and
the third support rib and the fourth support rib are connected via a second bent-back portion in an arc shape, which is wider than a distance between outer edges of the third support rib and the fourth support rib.

[4] The mirror member of [3], wherein
the first bent-back portion bulges toward the rotation center side relative to the inner edge, and
the second bent-back portion bulges toward the inner edge side relative to the rotation center.

[5] The mirror member of [1], wherein the third support rib is formed longer than the second support rib.

[6] The mirror member of [1], wherein the second support rib extends from the first support rib side toward the third support rib side while tapering toward the rotation center side.

[7] The mirror member of any one of [1] to [6], wherein *the fifth support rib is formed longer than a distance from the mirror to the outer edge of the fourth support rib.

[8] The mirror member of [2], wherein
the second support rib and the third support rib are connected via a first bent-back portion in an arc shape, which is wider than a distance between outer edges of the second support rib and the third support rib,
the third support rib and the fourth support rib are connected via a second bent-back portion in an arc shape, which is wider than a distance between outer edges of the third support rib and the fourth support rib,
the first bent-back portion bulges toward the rotation center relative to the inner edge,
the second bent-back portion bulges toward the inner edge side relative to the rotation center,
the third support rib is formed longer than the second support rib,
the second support rib extends from the first support rib side toward the third support rib side while tapering toward the rotation center side, and
the fifth support rib is formed longer than a distance from the mirror to the outer edge of the fourth support rib.

What is claimed is:

1. A mirror member, comprising:
a main frame; a mirror; and a plurality of support parts that radially connect an inner edge of the main frame and the mirror, wherein
each of the support parts includes:
a first support rib connected to the mirror and extending in a radial direction from a rotation center of the mirror to the inner edge;
a second support rib connected to the first support rib and extending in a first circumferential direction about the rotation center;
a third support rib connected to the second support rib and extending in a second circumferential direction, opposite to the first circumferential direction, on an outer diameter side of the rotation center with respect to the second support rib;
a fourth support rib connected to the third support rib and extending in the first circumferential direction outward of the rotation center with respect to the third support rib; and
a fifth support rib extending in the radial direction from the fourth support rib and connecting to both the fourth support rib and the inner edge.

2. The mirror member of claim 1, wherein the first support rib is positioned in the second circumferential direction relative to the fifth support rib.

3. The mirror member of claim 1, wherein
the second support rib and the third support rib are connected via a first bent-back portion in an arc shape, which is wider than a distance between outer edges of the second support rib and the third support rib, and
the third support rib and the fourth support rib are connected via a second bent-back portion in an arc shape, which is wider than a distance between outer edges of the third support rib and the fourth support rib.

4. The mirror member of claim 3, wherein
the first bent-back portion bulges toward the rotation center relative to the inner edge, and
the second bent-back portion bulges toward an inner edge side relative to the rotation center.

5. The mirror member of claim 1, wherein the third support rib is formed longer than the second support rib.

6. The mirror member of claim 1, wherein the second support rib extends from a first support rib side toward a third support rib side while tapering toward the rotation center side.

7. The mirror member of claim 1, wherein the fifth support rib is formed longer than a distance from the mirror to the outer edge of the fourth support rib.

8. The mirror member of claim 2, wherein
the second support rib and the third support rib are connected via a first bent-back portion in an arc shape, which is wider than a distance between outer edges of the second support rib and the third support rib,
the third support rib and the fourth support rib are connected via a second bent-back portion in an arc shape, which is wider than a distance between outer edges of the third support rib and the fourth support rib,
the first bent-back portion bulges toward the rotation center relative to the inner edge,
the second bent-back portion bulges toward an inner edge side relative to the rotation center,
the third support rib is formed longer than the second support rib,
the second support rib extends from a first support rib side toward a third support rib side while tapering toward the rotation center side, and
the fifth support rib is formed longer than a distance from the mirror to the outer edge of the fourth support rib.
